(19) United States
(12) Patent Application Publication
(10) Pub. No.: US 2020/0097939 A1
(43) Pub. Date: Mar. 26, 2020

(54) PAYMENT TERMINAL FOR A FUEL DISPENSING UNIT

(71) Applicant: Wayne Fueling Systems Sweden AB, Malmo (SE)

(72) Inventors: Hanna Helgesson, Dalby (SE); Bengt I. Larsson, Skivarp (SE)

(21) Appl. No.: 16/577,128

(22) Filed: Sep. 20, 2019

(30) Foreign Application Priority Data
Sep. 21, 2018 (SE) 1851124-6

(51) Int. Cl. G06Q 20/20; B67D 7/08

(52) U.S. Cl. CPC G06Q 20/204; B67D 7/08; G06Q 20/206

(57) ABSTRACT

The invention relates to a payment terminal for a fuel dispensing unit. The payment terminal comprises a user interface arranged in an upper section of the payment terminal, and a key pad arranged below the user interface. The payment terminal is characterized in that it has a user interface control means arranged below the user interface, the user interface control means being connected to the user interface for control thereof.

### CROSS-REFERENCE TO RELATED APPLICATIONS

This application claims priority to Swedish Patent Application No. 1851124-6 filed on Sep. 21, 2018, which is herein incorporated by reference in its entirety.

### FIELD

The invention relates to a payment terminal for a fuel dispensing unit.

### BACKGROUND

When refueling a tank of a motor vehicle today, it is a common measure to pay for the fuel using a self-service payment terminal. The use of a payment terminal instead of paying inside a gas station facilitates the refueling process and saves time for a user.

Today, different markets have different requirements regarding heights for payment terminals. Due to the different requirements and regulations in different markets, in combination with different installation designs, different heights, especially in respect of the user interface mechanism, are required. For example, some countries require ADA standards while other have regulations regarding zoning on a gas station. The installation of the freestanding payment terminal can also vary from station to station, due to islands and orientation.

A problem associated with payment terminals according to known prior art is therefore the configuration of the same in order to comply with the different height requirements on each market. To be able to cover the wide market, due to the regulations and demands regarding heights, different versions of the complete payment terminal has been designed. These payment terminals are often large in size which is a disadvantage around movable vehicles from a safety perspective.

### SUMMARY

It is an objective of the present invention to mitigate, alleviate or eliminate one or more of the above-identified deficiencies in the art and disadvantages singly or in any combination and solve at least the above mentioned problems.

According to a first aspect of the invention, these and other objects are achieved, in full or at least in part, by a payment terminal for a fuel dispensing unit. The payment terminal comprises a user interface arranged in an upper section of the payment terminal, and a key pad arranged below the user interface. The payment terminal is characterized by a user interface control means arranged below the user interface, the user interface control means being connected to the user interface for control thereof.

This is advantageous in that the combination of the user interface and the user interface control means (as well as their placement) enable satisfactory use of the payment terminal for both standing users and disabled users. The user interface may accordingly be used directly (preferably at a higher position in relation to the payment terminal, e.g. when used by a standing user) or via the user interface control means (preferably at a lower position in relation to the payment terminal, e.g. when used by a chair bound user).

In turn, this means that it will be possible to manufacture one single payment terminal which accordingly can be adapted to fulfill the requirements of any existing market, worldwide. Naturally, as a consequence, both time and money will be saved.

The payment terminal is also given a slim design which enhances the visibility around the fuel dispensing unit for a user. This is important from a safety perspective.

The user interface may comprise a touch screen.

The user interface control means may comprise a touch pad.

The touch pad may be arranged at a predetermined height from the ground to facilitate use of the payment terminal for a disabled user.

The touch pad may be arranged in an inclined manner in relation to the user interface.

The payment terminal may have a first main portion and a second main portion, the second main portion being inclined in relation to the first main portion in order to form a L-shaped or a J-shaped payment terminal.

According to a second aspect of the invention, these and other objects, and/or advantages that will be apparent from the following description of embodiments, are achieved, in full or at least in part, by a payment terminal for a fuel dispensing unit. The payment terminal comprises a user interface arranged in an upper section of the payment terminal, and a key pad arranged below the user interface. The payment terminal is characterized in that it has a first main portion and a second main portion, the second main portion being inclined in relation to the first main portion.

This is advantageous in that the new and inventive payment terminal is given a slim design which enhances the visibility around the fuel dispensing unit for a user. This is important from a safety perspective. The design will also facilitate the removal of rain water from the payment terminal since it will simply run off from the inclined surfaces.

The second main portion may be inclined at an angle of between 90° and 130° in relation to the first main portion.

The payment may further comprise a curved portion between the first main portion and the second main portion in order to form a J-shaped payment terminal.

The payment may further comprise a user interface control means in the form of a touch pad arranged below the user interface, the touch pad being connected to the user interface for control thereof.

The touch pad may be arranged in the second main portion of the payment terminal.

The payment terminal may further comprise a card reader which is arranged on an outer edge of the second main portion of the payment terminal. By arranging the card reader on an outer edge of the lower section of the payment terminal it accommodates the space constraints of ADA standards while simultaneously providing protection to the reader from the outdoor elements.

The key pad may be arranged in a recess provided in the first main portion and just above the second main portion of the payment terminal.

Theft of passwords, pass codes and PIN-codes for credit cards and charge cards etc. at transactions terminals such as payment terminals at petrol stations is a widespread problem. For example, a fraudulent party may steal the code by secretly looking over the shoulder of an unsuspecting user of the terminal. A more elaborate way of stealing the code is to mount a camera at the transaction terminal and record what keys of the keypad the user presses. Typically, in such a situation, the camera is mounted above the keypad. By arranging the key pad in the recess of the first main portion, the view of the keypad is prevented in at least some directions and thus prevents a fraudulent party from viewing the keypad.

The user interface may be arranged in the first main portion of the payment terminal and adapted to face a user.

The user interface may comprise a touch screen.

According to a third aspect of the invention, these and other objects are achieved, in full or at least in part, by a fuel dispensing unit comprising a payment terminal according to the features described above.

Effects and features of the second and third aspects of the present invention are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

As used herein, the term “comprising” and variations of that term are not intended to exclude other additives, components, integers or steps.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals may be used for similar elements, and wherein:

FIG. 1 is a perspective view of one exemplary embodiment of a payment terminal according to a first aspect of the invention.

FIG. 2 is a perspective view of one exemplary embodiment of a payment terminal according to a second aspect of the invention.

FIG. 3 is a perspective view of one exemplary embodiment of a fuel dispensing unit according to a third aspect of the invention.

### DETAILED DESCRIPTION

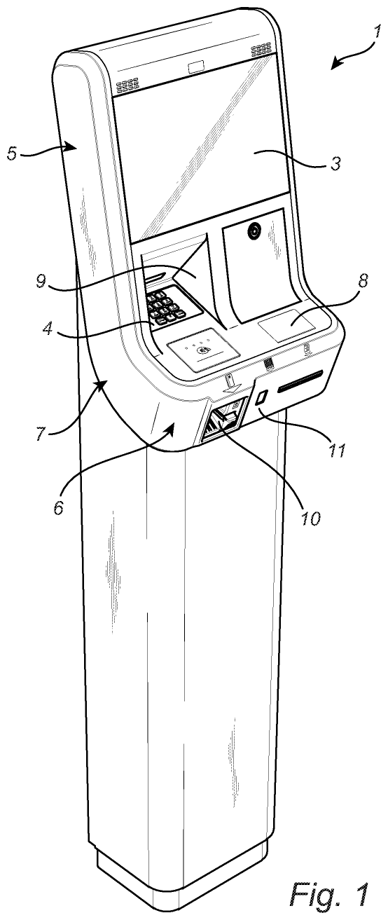

FIG. 1 illustrates an exemplary embodiment of a payment terminal 1 for a fuel dispensing unit 2. The payment terminal 1 comprises a user interface 3 arranged in an upper section of the payment terminal 1, and a key pad 4 arranged below the user interface 3.

The payment terminal 1 has a first main portion 5 and a second main portion 6. The second main portion 6 is inclined at an angle of approximately 120° in relation to the first main portion 5. A curved portion 7 is arranged between the first main portion 5 and the second main portion 6 in order to form an overall J-shaped payment terminal 1.

In this specific embodiment, the first main portion 5 of the payment terminal 1 is inclined at an angle of between 10° and 30° in relation to a vertical direction from the ground. Naturally, other angles are also possible, such as the first main portion 5 being aligned with the vertical direction from the ground.

The user interface 3 comprises a touch screen and is arranged in the first main portion 5 of the payment terminal 1 adapted to face a user. The payment terminal 1 further comprises a user interface control means 8 in the form of a touch pad arranged below the user interface 3 in the second main portion 6. The touch pad 8 is connected to the user interface 3 for control thereof. The key pad 4 is arranged in a recess 9 provided in the first main portion 5 and just above the second main portion 6 of the payment terminal 1. This way, the view of the keypad 4 is prevented in at least some directions and thus prevents a fraudulent party from viewing the keypad 4.

A card reader 10 is arranged on an outer edge 11 of the second main portion 6 of the payment terminal 1. By arranging the card reader 10 on the outer edge 11 of the lower section of the payment terminal 1 it accommodates the space constraints of ADA standards while simultaneously providing protection to the reader from the outdoor elements.

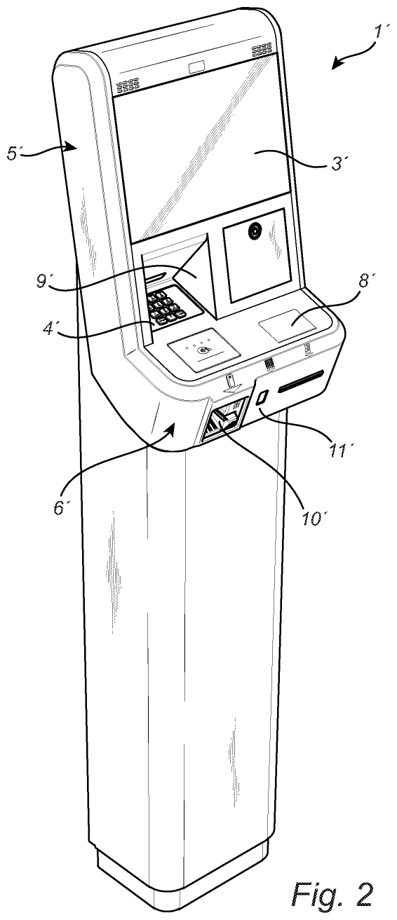

FIG. 2 illustrates another exemplary embodiment of a payment terminal 1′ for a fuel dispensing unit 2. The payment terminal 1′ comprises a user interface 3′ arranged in an upper section of the payment terminal 1′, and a key pad 4′ arranged below the user interface 3′. The payment terminal 1′ has a user interface control means 8′ in the form of a touch pad arranged below the user interface 3′ which is connected to the user interface 3′ for control thereof.

The user interface 3′ comprises a touch screen and the touch pad 8′ is arranged at a predetermined height from the ground to facilitate use of the payment terminal 1′ for a disabled user.

This way, the user interface 3′ and the touch pad 8′ enable satisfactory use of the payment terminal 1′ for both standing users and disabled users. The user interface 3′ may accordingly be used directly (preferably at a higher position in relation to the payment terminal 1′, e.g. when used by a standing user) or via the touch pad 8′ (preferably at a lower position in relation to the payment terminal 1′, e.g. when used by a chair bound user).

The payment terminal 1′ has a first main portion 5′ and a second main portion 6′. The second main portion 6′ is inclined in relation to the first main portion 5′ at an angle of approximately 120° in order to form a L-shaped payment terminal 1′.

The key pad 4′ is arranged in a recess 9′ provided in the first main portion 5′ and just above the second main portion 6′ of the payment terminal 1′. This way, the view of the keypad 4′ is prevented in at least some directions and thus prevents a fraudulent party from viewing the keypad 4′.

A card reader 10′ is arranged on an outer edge 11′ of the second main portion 6 of the payment terminal 1′. By arranging the card reader 10′ on an outer edge 11′ of the lower section of the payment terminal 1′ it accommodates the space constraints of ADA standards while simultaneously providing protection to the reader from the outdoor elements.

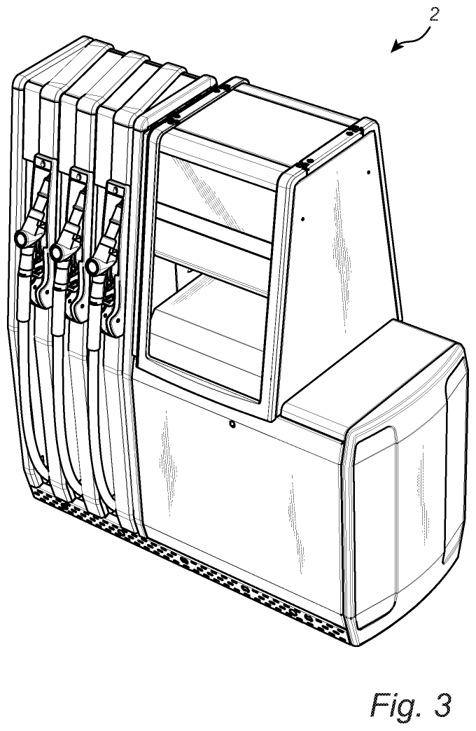

FIG. 3 illustrates an exemplary embodiment of a fuel dispensing unit 2. The fuel dispensing unit 2 is connected to a payment terminal 1, 1′ according to the features described above.

It is understood that other variations in the present invention are contemplated and in some instances, some features of the invention can be employed without a corresponding use of other features. Accordingly, it is appropriate that the appended claims be construed broadly in a manner consistent with the scope of the invention.

For instance, the number, size and shape of the components of the payment terminal 1 may be varied in any suitable way.

As stated above, the payment terminal (1, 1′) may be both J-shaped and L-shaped.

The payment terminal (1, 1′) may include a user interface control means (8, 8′) adapted to control the user interface (3, 3′). The user interface control means (8, 8′) may comprise a touch pad but other options are also possible, such as for example a trackball mouse or the like.

What is claimed is:

1. A payment terminal for a fuel dispensing unit, comprising:
a user interface arranged in an upper section of the payment terminal; and
a key pad arranged below the user interface; and
a user interface control means arranged below the user interface, the user interface control means being connected to the user interface for control thereof.

2. The payment terminal of claim 1, wherein the user interface comprises a touch screen.

3. The payment terminal of claim 1, wherein the user interface control means is arranged at a predetermined height from the ground to facilitate use of the payment terminal for a disabled user.

4. The payment terminal of claim 1, wherein the user interface control means is arranged in an inclined manner in relation to the user interface.

5. The payment terminal of claim 1, wherein the payment terminal has a first main portion and a second main portion, the second main portion being inclined in relation to the first main portion in order to form a L-shaped or a J-shaped payment terminal.

6. A payment terminal for a fuel dispensing unit, comprising:
a user interface arranged in an upper section of the payment terminal; and
a key pad arranged below the user interface;
wherein the payment terminal has a first main portion and a second main portion, the second main portion being inclined in relation to the first main portion.

7. The payment terminal of claim 6, wherein the second main portion is inclined at an angle of between 90° and 130° in relation to the first main portion.

8. The payment terminal of claim 6, further comprising a curved portion between the first main portion and the second main portion in order to form a J-shaped payment terminal.

9. The payment terminal of claim 6, further comprising a user interface control means arranged below the user interface, the touch pad being connected to the user interface for control thereof.

10. The payment terminal of claim 9, wherein the user interface control means is arranged in the second main portion of the payment terminal.

11. The payment terminal of claim 6, further comprising a card reader which is arranged on an outer edge of the second main portion of the payment terminal.

12. The payment terminal of claim 6, wherein the key pad is arranged in a recess provided in the first main portion and just above the second main portion of the payment terminal.

13. The payment terminal of claim 6, wherein the user interface is arranged in the first main portion of the payment terminal and adapted to face a user.

14. The payment terminal of claim 6, wherein the user interface comprises a touch screen.
